(19) United States
(12) Patent Application Publication
(10) Pub. No.: US 2015/0026012 A1
(43) Pub. Date: Jan. 22, 2015

(54) SYSTEMS AND METHODS FOR ONLINE PRESENTATION OF STOREFRONT IMAGES

(71) Applicants: Ron Gura, Tel-Aviv (IL); Erez Dickman, Tel-Aviv (IL); Matanya Bar, Tel-Aviv (IL)

(72) Inventors: Ron Gura, Tel-Aviv (IL); Erez Dickman, Tel-Aviv (IL); Matanya Bar, Tel-Aviv (IL)

(21) Appl. No.: 14/182,991

(22) Filed: Feb. 18, 2014

Related U.S. Application Data
(60) Provisional application No. 61/846,884, filed on Jul. 16, 2013.

(51) Int. Cl. G06Q 30/06

(52) U.S. Cl. CPC G06Q 30/0643; G06Q 30/0625
USPC 705/26.62

(57) ABSTRACT

An search query may be received from a user device, the search query indicating retail-related search criteria. A user device may be caused to display a search result based on the search query. The search result may comprise one or more search result items respectively comprising a storefront image representing a storefront of a corresponding brick-and-mortar store. A respective plurality of merchandise items may be visible in each storefront image.

### RELATED APPLICATION

This application claims the priority benefit of U.S. Provisional Patent Application No. 61/846,884, filed Jul. 16, 2013, which is incorporated herein by reference in its entirety.

### TECHNICAL FIELD

The subject matter disclosed herein generally relates to the processing of data. More particularly, the present disclosure addresses online search systems and methods, and to systems and methods to present a virtual storefront for an online vendor.

### BACKGROUND

Brick-and-mortar retail stores often have a storefront or shopfront located on the ground floor or street level of a commercial building. Such storefronts typically include one or more display windows in which a selection of merchandise items available at the store is displayed. Sales information (such as purchase price, available discount, special deals details, or the like) can often be displayed in the storefront in association with the merchandise items. Significant thought and effort are often invested in design and layout of such storefronts, not only to provide an aesthetically pleasing display, but also to reflect a particular brand image, style and/or atmosphere associated with the retail store.

### BRIEF DESCRIPTION OF THE DRAWINGS

Some embodiments are illustrated by way of example and not limitation in the figures of the accompanying drawings.

FIG. 1 is a network diagram illustrating a network environment suitable to display a storefront image, according to some example embodiments.

FIG. 2 is a block diagram illustrating components of an image machine, according to some example embodiments.

FIG. 3-5 are example user interfaces of a storefront image, according to some example embodiments.

FIG. 6 is an example user interface of an online page that corresponds to the brick-and-mortar store, according to some example embodiments.

FIG. 7-8 is a flowchart illustrating a method of causing a display to present a virtual storefront that includes a storefront image, according to some example embodiments.

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems are directed to displaying a storefront image of a brick-and-mortar store as an online representation of the store or an associated commercial entity. The method may comprise providing an online window-shopping facility. This may include presenting search results for an online search by displaying respective storefront images for a plurality of stores or vendors that satisfy a user-provided search query. In some embodiments, the method may include providing a virtual storefront for an online vendor based on a storefront image for a brick-and-mortar store. This may provide a user the advantage of viewing the respective storefront images for the plurality of stores without having to travel outside and physically stand in front of each of the plurality of stores. Moreover, the storefront of a brick-and-mortar store may be aesthetic, inspiring, and may convey a sense of style to its viewers, thereby being more advantageous to allow a user to view the storefronts rather than having to browse an online catalog corresponding to the brick-and-mortar store. Business owners of the brick-and-mortar stores also benefit because the online window-shopping facility may increase exposure of their storefronts in order to communicate to users of the window shopping facility information associated with their brick-and-mortar stores.

In the following description, for purposes of explanation, numerous specific details are set forth to provide a thorough understanding of example embodiments. It will be evident to one skilled in the art, however, that the present subject matter may be practiced without these specific details. Some components and functions are optional and may be combined or subdivided, and operations may vary in sequence or be combined or subdivided.

The method may comprise causing display on a user device of a storefront image of a particular brick-and-mortar store in response to receiving an online query associated with the brick-and-mortar store. In some embodiments, the query may be a search query, with the storefront image being presented as part of a search result entry for the particular store. The method may comprise providing an online search facility which presents search results primarily as respective storefront images for each of a plurality of stores or commercial entities that satisfy search criteria of the search query. As will be described in greater detail below, each search result item may in some embodiments be presented as virtual storefront that comprises an augmented storefront image of the corresponding brick-and-mortar storefront, for example to make item-specific merchandise information available to the user.

The user may perform the search in a various ways. For instance, the user may provide a description of the brick-and-mortar store as search criteria, for example by searching by store name. In other instances, the query may comprise a location-based search, for example comprising search criteria for an associated store type within a geographical vicinity of a mobile electronic device, or within a particular geographic area.

In response to the respective query, a publication server may present the virtual storefront, comprising the image of the brick-and-mortar storefront and including the merchandise items displayed in the brick-and-mortar storefront. The virtual storefront thus provides a visual experience corresponding to that experienced through personal presence at the brick-and-mortar storefront, displaying to an online user a selection of merchandise items available, as well as reflecting the style, culture, and general feel of the brick-and-mortar store. Instead, or in addition, the storefront image may be displayed as a search result item in response to a search query for a particular merchandise item represented in the storefront image. In such cases, a user search query for a particular type of merchandise item (say a pair of shoes of a specified color and brand name) may result in presentation of the search results as a plurality of brick-and-mortar storefront images, in each of which is present the particular type of merchandise item (each storefront image for example including among its respective selection of merchandise items a pair of shoes that is of the specified color and brand name).

The method may comprise providing an online search facility that presents search results primarily based on respective brick-and-mortar storefront images. In some instances, the search results may substantially exclusively being storefront image-based. Searching for particular merchandise items, browsing stores in a particular geographic area or browsing stores of a particular type, for example, through use of the online search facility may thus provide the user with an online window-shopping experience.

As mentioned, merchandise information for the merchandise items visible in the storefront image may also be displayed in association with the respective merchandise items, to provide a virtual storefront based on the brick-and-mortar storefront image. In some embodiments, the virtual storefront may be augmented to provide interactive information display. A virtual tag may for example, be displayed in association with each merchandise item in the virtual storefront. The virtual tags may in such cases comprise interactive user interface elements that are selectable by a user to provide further information about the corresponding merchandise item.

The virtual storefront may be e-commerce enabled, to allow purchase of merchandise items via the virtual storefront. In some embodiments, the virtual storefront may be presented in context other than search results. The virtual storefront may, for example, be accessible via an online store associated with the brick-and-mortar store. The query in response to which the storefront image is displayed may in such cases comprise accessing a website of an online merchant associated with the brick-and-mortar store. A commercial entity that operates the brick-and-mortar store may, for example, provide a corresponding website providing e-commerce facilities with respect to overlapping or identical merchandise available at the brick-and-mortar store. The virtual storefront for the corresponding web-site may thus be based at least in part on the storefront image (e.g., a digital photograph of the brick-and-mortar storefront). A user query resulting in online presentation of the virtual storefront may thus include user entry in a browser of a URL (Uniform Resource Locator) unique to the website, or user selection of a link to the website.

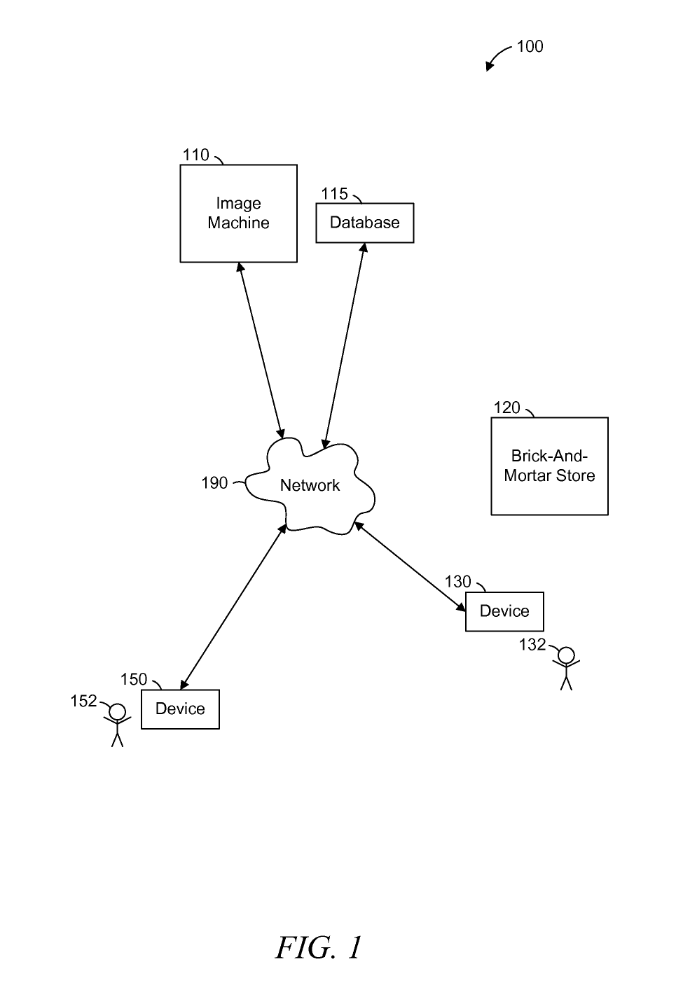

FIG. 1 is a network diagram illustrating a network environment 100 suitable for online presentation of storefront images, according to some example embodiments. The network environment 100 includes an image machine 110, a database 115, and devices 130, and 150, all communicatively coupled to each other via a network 190.

Also shown in FIG. 1 are client 132 and user 152. One or both of the client 132 and user 152 may be a human user (e.g., a human being), a machine user (e.g., a computer configured by a software program to interact with the client device 130), or any suitable combination thereof (e.g., a human assisted by a machine or a machine supervised by a human). The client 132 is not part of the network environment 100, but is associated with the client device 130 and may be a user of the client device 130. For example, the client device 130 may be a desktop computer, a vehicle computer, a tablet computer, a navigational device, a portable media device, or a smart phone belonging to the client 132. Likewise, the user 152 is not part of the network environment 100, but is associated with the device 150. As an example, the device 150 may be a desktop computer, a vehicle computer, a tablet computer, a navigational device, a portable media device, or a smart phone belonging to the user 152.

An image of a storefront of the brick-and-mortar store 120 may be captured for use as representation of the brick-and-mortar store 120 as an online search result item, and/or for use in providing a virtual online storefront for the store 120. In this example embodiment, capturing of the storefront image comprises the taking of a digital picture by client 132 via a native camera of client device 130 (in this example embodiment being a mobile phone). The image may be of the brick-and-mortar storefront as a whole, showing merchandise items displayed in the storefront of the brick-and-mortar store 120. The captured storefront image may thereafter be uploaded to the image machine 110, via the client device 130 and the network 190. The image machine 110 may generate a virtual storefront based at least in part on the storefront image.

The image machine 110 may subsequently present the virtual storefront to a user (e.g., user 152) by displaying the virtual storefront (including the storefront image) on a user device (e.g., device 150). The image may be presented in response to the image machine 110 receiving an online query from the user device (e.g., device 150).

Any of the machines, databases, or devices shown in FIG. 1 may be implemented in a general-purpose computer modified (e.g., configured or programmed) by software to be a special-purpose computer to perform one or more of the functions described herein for that machine, database, or device. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the image machine 110 and the client device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

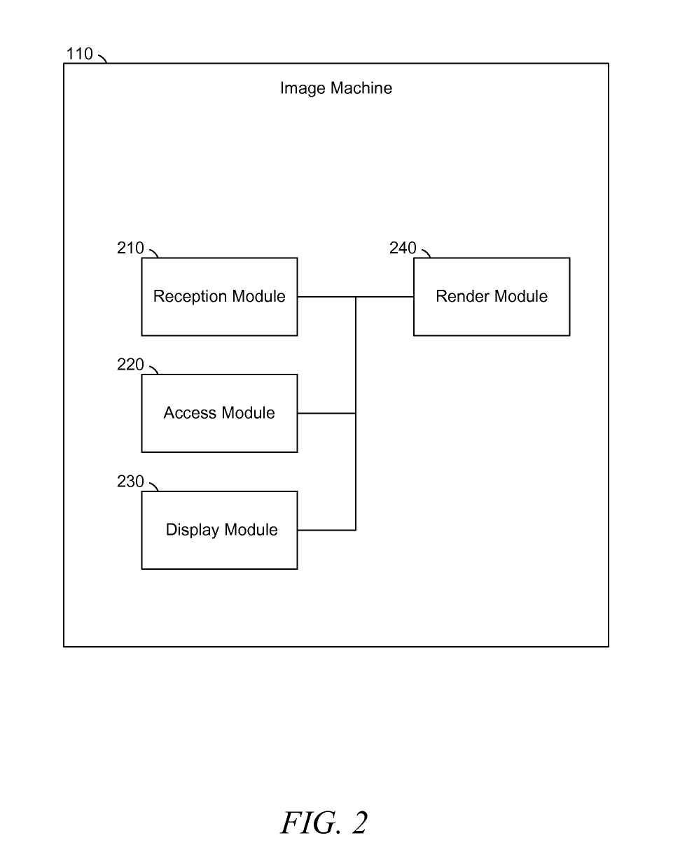

FIG. 2 is a block diagram illustrating components of the image machine 110, according to some example embodiments. The image machine 110 is shown as including a reception module 210, an access module 220, a display module 230, and a render module 240, all configured to communicate with each other (e.g., via a bus, shared memory, or a switch). In various example embodiments, the reception module 210 is configured to receive from a user device a search query indicating retail-related search criteria, as further explained below.

In various example embodiments, the reception module 210 is configured to receive the storefront image from a client device (e.g., client device 130) for use as representation of the brick-and-mortar store 120 as an online search result item, and/or for use in presenting a virtual storefront for the brick-and-mortar store 120. The reception module may further be configured to receive from the client 132 (e.g. via client device 130) merchandise information pertaining to merchandise items visible in the storefront image.

In some example embodiments, the reception module 210 is further configured to receive (e.g., from the client 132 via client device 130) an updated storefront image of the brick-and-mortar store 120. The updated image may be used to update the virtual storefront hosted by the image machine and accessed by access module 220, as further explained below.

The reception module 210 may further be configured to receive from a user device (e.g., device 150) an online query associated with a brick-and-mortar store 120. In some example embodiments, the reception module 210 is configured to receive queries in the form of search queries, and to display the virtual storefront as part of a search result. The virtual storefront may, for example, be presented in response to a search query having such criteria satisfied by the geographical location and/or identity of the brick-and-mortar store 120. Instead, or in addition, the virtual storefront may be presented in response to a search query having search criteria that satisfy one or more of the merchandise items available at the brick-and-mortar store 120.

In various example embodiments, the reception module 210 is further configured to receive location data of the user device (e.g., device 150). The location data of the user device (e.g., device 150) may be obtained via a GPS receiver attached to the user device and retrieved from the user device. In such cases, a search performed responsive to the search query may be based at least in part on the location data. For example, a user-provided search query for nearby stores dealing in a specified type of merchandise may result in display of respective storefront images for each of a plurality of brick-and-mortar stores that deal in the specified type of merchandise and are located within a threshold distance of the user device location, as indicated by the location data.

Instead, or in addition, the reception module 210 may further be configured to receive a URL query associated with the virtual storefront. The reception module 210 may in such cases be configured to respond to request for display of a website or web page on which the virtual storefront is to be displayed, for example by detecting selection of a link included in an online page corresponding to the brick-and-mortar store 120. Selection of the link may be performed on the user device (e.g., device 150). For instance, the user may be browsing the online page corresponding to the brick-and-mortar store 120 on the user device (e.g., device 150). The online page may include a link that will cause display of the virtual storefront on the user device 150. As an example, the link may be labeled as “Click to View Storefront” and displayed on the online page of the brick-and-mortar store. This may enable the user to have a more immersive visual experience when browsing the online page corresponding to the brick-and-mortar store 120.

In some embodiments, the virtual storefront based at least in part on the brick-and-mortar storefront image may be presented on a home page of a website associated with the brick-and-mortar store 120, so that a user's first view of the website is provided by the virtual storefront. In this manner, the brick-and-mortar store 120 and a corresponding e-commerce facility have respective storefronts that are identical or analogous in appearance. In some instances, separate virtual storefronts may be provided for different brick-and-mortar stores in a chain of stores or a franchise. In other instances, a single, universal virtual storefront may be provided for a plurality of brick-and-mortar stores forming part of the same chain or franchise. Such a universal virtual storefront may be based on a brick-and-mortar storefront image captured at a flagship store.

In various example embodiments, an online search facility may provide an online page that may be used by the user to provide the store-related search criteria and/or merchandise item-related search criteria. For instance, the online page may include search fields that are useable to provide the search criteria. The search fields may enable the user to provide a description of an item, location information, and any suitable combination thereof as search criteria. In various example embodiments, the reception module 210 is further configured to receive search criteria that indicate the brick-and-mortar store 120 (e.g., address of the brick-and-mortar store 120, name of the brick-and-mortar 120, and/or description of the brick-and-mortar store 120).

In various example embodiments, the access module 220 is configured to access the storefront image of the brick-and-mortar store 120. For instance, an image that depicts the storefront of a local bookstore may be accessed by the access module 220. The storefront image may be accessed from a database 112. Moreover, the storefront image may be previously captured by another device (e.g., client device 130) operated by another user (e.g., client 132) and stored in the database 112 by the reception module 210. For instance, an owner of the brick-and-mortar store 120 may step outside capture a picture of the storefront. The captured picture may then by uploaded by the owner to the database 112 to be accessed by the accessed module 220. Moreover, the storefront of the brick-and-mortar store 120 may display merchandise items available at the brick-and-mortar store. In the case of the local bookstore, the storefront may display books on sale at the local bookstore. In the case of a clothing store, the storefront may display items of clothing on sale.

In various example embodiments, the access module is further configured to access the storefront image based on the location of the user device (e.g., device 150) received at the reception module 210. For instance, the access module 220 may compare the location of the brick-and-mortar store 120 with the location of the user device (e.g., device 150) and determine that a distance between the locations of the user device and the brick-and-mortar store is within a predetermined threshold. The location of the brick-and-mortar store 120 may be stored in the database 112. In various example embodiments, the location of the brick and mortar store 120 may correspond to the location of the further device (e.g., client device 130) used to capture the image of the storefront of the brick-and-mortar store 120. For instance, the location of the brick-and-mortar store 120 may be determined as the location of a smart phone used to capture the image of the brick-and-mortar store 120. In various example embodiments, the access module 220 is further configured to access the storefront image based on the search criteria that match with the one or more of the merchandise items at the brick-and-mortar store. For instance, the search criteria received at the reception module 210 may be a description for “black boots”. The access module 220 may determine that the storefront image includes an image for “black boots” and may therefore access the storefront image. As another example, the search criteria may be a description of a book, such as a book title, or author. The access module 220 may access the storefront image based on the description of the book. The accessed storefront image may depict a storefront including the book that matches the search criteria as being on display. Alternatively, the search criteria may indicate the brick-and-mortar store 120 (e.g., address of the brick-and-mortar store 120, name of the brick-and-mortar 120, description of the brick-and-mortar store 120). The access module 220 may access the storefront image based on the search criteria that indicates the brick-and-mortar store 120. In various example embodiments, the access module 220 is further configured to access the storefront image based on the operation of the link included in the online page corresponding to the brick-and-mortar store 120.

In various example embodiments, the access module 220 is further configured to maintain a database of storefront images for respective brick-and-mortar stores (e.g., database 112). Moreover, the access module 220 may be further configured to receive an updated storefront image for a specific brick-and-mortar store represented in the database by an outdated storefront image. As a result, the access module 220 may be further configured to replace the outdated storefront image for the specific brick-and-mortar store in the database with the updated storefront image.

In various example embodiments, the display module 230 is configured to cause a display on the user device of a search result based on the search query, the search result comprising one or more search result items respectively comprising a storefront image representing a storefront of a corresponding brick-and-mortar store, wherein a respective plurality of merchandise items is visible in each storefront image. In various example embodiments, the access module 220 is configured to access the search result comprising one or more search result items respectively comprising the storefront image representing the storefront of the corresponding brick-and-mortar store. Each search result item may comprise an augmented storefront view based on the corresponding storefront image. The augmented storefront view may include respective merchandise information for the associated plurality of merchandise items. The augmented storefront view may further include a plurality of user interface elements associated with respective corresponding merchandise items. In various example embodiments, the augmented storefront view is rendered by the render module 240, as further explained below. In various example embodiments, the display module 230 is further configured to cause display of storefront image-based search result items for a plurality of brick-and-mortar stores that satisfy the search criteria and that are located within a predetermined threshold data from the user device, as indicated by the received location data received at the reception module 210.

In various example embodiments, the display module 230 is further configured to cause a display on the user device (e.g., device 150) to present the virtual storefront that includes the storefront image accessed by the access module 220. As mentioned, the display module 230 may cause the display to present the virtual storefront in response to the received online query from the user device. Moreover, the virtual storefront may include respective merchandise information for one or more of the merchandise items represented in the storefront image. Merchandise information may include price of the merchandise items, description of the merchandise items, a link to an online page featuring the item, and any suitable combination thereof. In various example embodiments, the display module 230 is further configured to display the virtual storefront such that it comprises an augmented view of the storefront image, in which user interface elements are displayed in association with respective merchandise items. In various example embodiments, the display module 230 is further configured to display the respective merchandise information in response detecting user interaction with the user interface elements. In some embodiments, each user interface element comprises a generic price tag. In such cases, user interaction with the user interface elements (for example mouse-clicking or scrolling over a particular virtual price tag) may trigger display of item-specific merchandise information, such as price, product details, and availability information. In payments in which the virtual storefront is e-commerce enabled, user interaction with a particular user interface element may trigger display of e-commerce UI elements.

Augmentation of the storefront image may be rendered by the render module 240, as further explained below. In various example embodiments, the display module 230 is further configured to display on the user device the updated image received at the reception module 210. The updated image may include updated merchandise items available at the brick-and-mortar store 120. For instance, the items displayed in the storefront of the brick-and-mortar store 120 may change over time, for example due to changes in merchandise stock, redesign of the brick-and-mortar storefront, or themed storefront displays (e.g., Christmas or Halloween displays). The original items may be replaced with new items. As a result, the updated image may capture the new items displayed in the storefront of the brick-and-mortar store 120. The updated image may be received from a further device (e.g., client device 130) operated by a further user (e.g., client 132) that is standing in front of the brick-and-mortar store 120. In various example embodiments, the display module 230 is further configured to display the storefront image on the online page corresponding to the brick-and-mortar store 120 in response to the reception module 210 detecting the operation of the link. As stated previously, the link may be included in the online page corresponding to the brick-and-mortar store 120. In various example embodiments, the display module 230 is further configured to display a map that includes the location of the user device (e.g., device 150) and the location of the brick-and-mortar store 120. The map may depict the location of the user device (e.g., device 150) and the location of the brick-and-mortar store 120. Moreover, the display module 230 may be further configured to display a path from the location of the user device (e.g., device 150) to the location of the brick-and-mortar store 120 in the displayed map.

In various example embodiments, the render module 240 is configured to render an augmentation of the storefront image that includes user interface elements displayed in associated with respective merchandise items. Each of the user interface elements may be operable to present merchandise information for the one or more merchandise items represented in the storefront image. In various example embodiments, the reception module 210 is further configured to detect operation of the user interface elements included in the augmentation of the storefront image. The operation of the overlay over the storefront image may be received from the user device (e.g., device 150). Moreover the display module 230 may be further configured to, in response to the detecting the user selection, cause display of merchandise information specific to the merchandise item corresponding to the particular user interface element. In various example embodiments, the render module 240 is configured to render a virtual price tag over each of the merchandise items represented in the storefront image. For instance, the virtual price tag may be depicted as being attached to the merchandise items or may be displayed near the merchandise items. Moreover, the merchandise information such as price, description, or title may be presented by the display module 230 in response to operation of the virtual price tags. The operation of the virtual price tags may be detected by the reception module 210.

In various example embodiments, the display module 230 is further configured to facilitate an online transaction via a particular augmented storefront view with respect to a user-selected merchandise item in the corresponding storefront image. In various example embodiments, the display module 230 is further configured to cause display of an e-commerce user interface in response to user selection of one of the plurality of user interface elements of the augmented storefront view.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

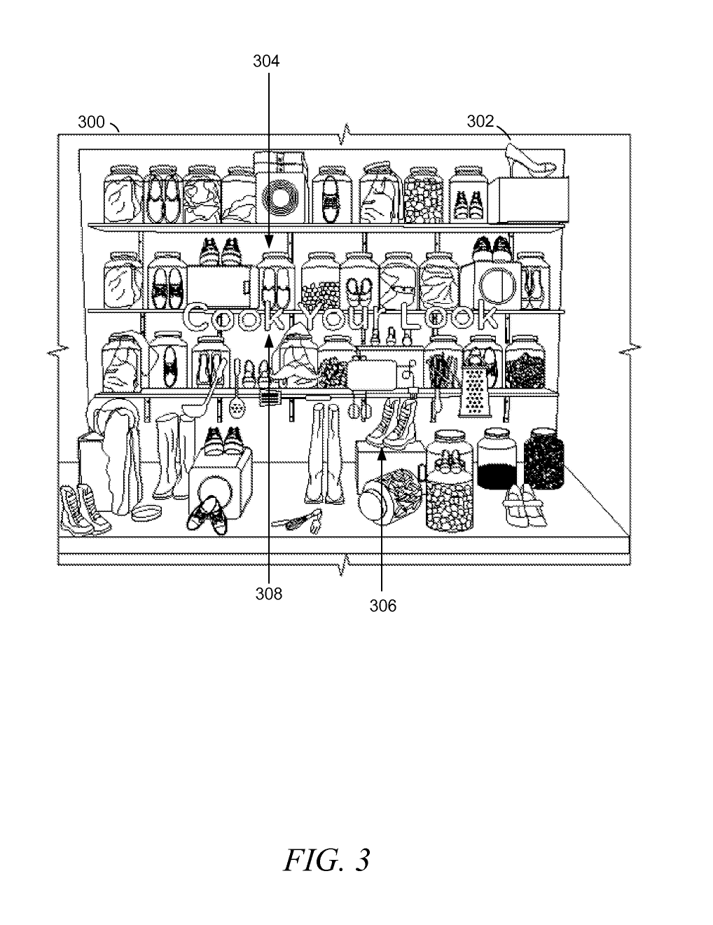

FIG. 3 is an example user interface of a storefront image 300, according to some example embodiments. The storefront image 300 is a digital photograph of a physical storefront of the brick-and-mortar store 120. The storefront image 300 is in this example taken from a position outside the store, and may thus include information displayed on a window separating the storefront from a sidewalk. In this example, a catchphrase 308 printed on the storefront window is visible in the storefront image 300. The storefront image 300 may include a depiction of several merchandise items, including a first item 302, a second item 304, and a third item 306 as displayed in the storefront of the brick-and-mortar store 120. Moreover, the first item 304, second item 306, and a third item 306 may be available to be purchased from the brick-and-mortar store 120.

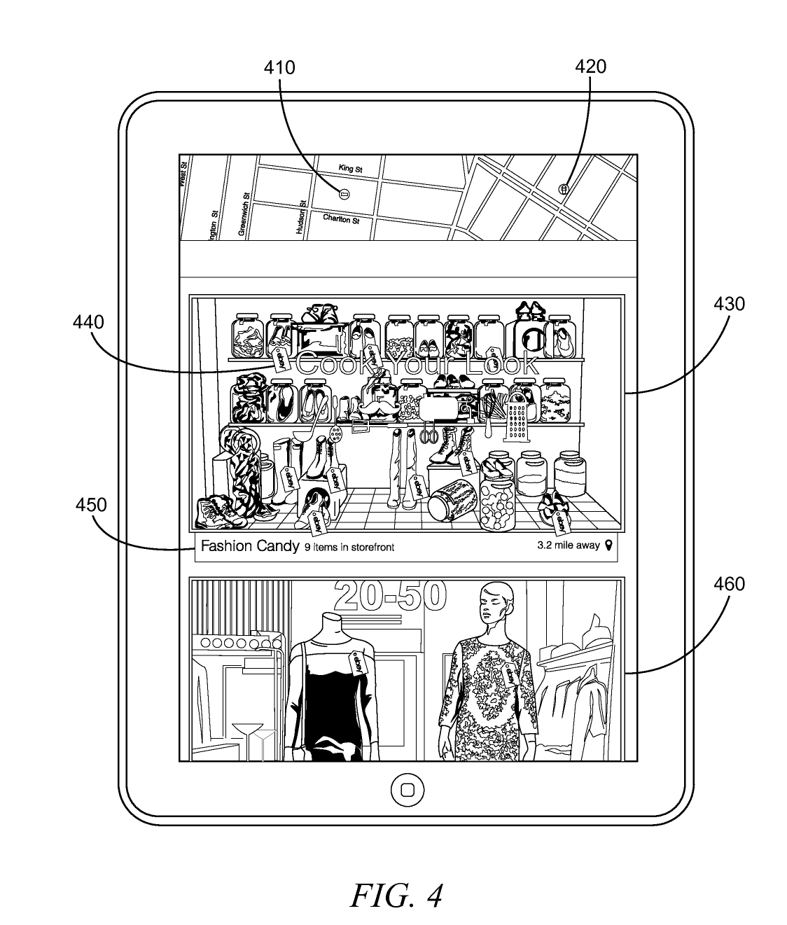

FIG. 4 is an example user interface of a plurality of storefront images, according to some example embodiments. The example user interface may be a search results page including a first storefront image 430 and a second storefront image 460. In various example embodiments, the first storefront image 430 is an augmented storefront view of the storefront image 300 of FIG. 3. The first storefront image 430 may include user interface elements capable of displaying merchandise information of merchandise items depicted the first storefront image 430. For instance, user interface element 440 may be rendered by the render module 240. The reception module 210 may detect operation of the user interface element 440. For instance, the storefront image 400 may be displayed in a user device (e.g., device 150) that belongs to a user (e.g., user 152). The user 152 may click on the user interface element 440. The first storefront image 430 may also include a description 450 about a brick-and-mortar store corresponding to the first storefront image 430 (e.g., brick-and-mortar store 120). Moreover, the example user interface may include a map depicting a location 410 of the brick-and-mortar store corresponding to the first storefront image 430 and a location 420 of a brick-and-mortar store corresponding to the second storefront image 460.

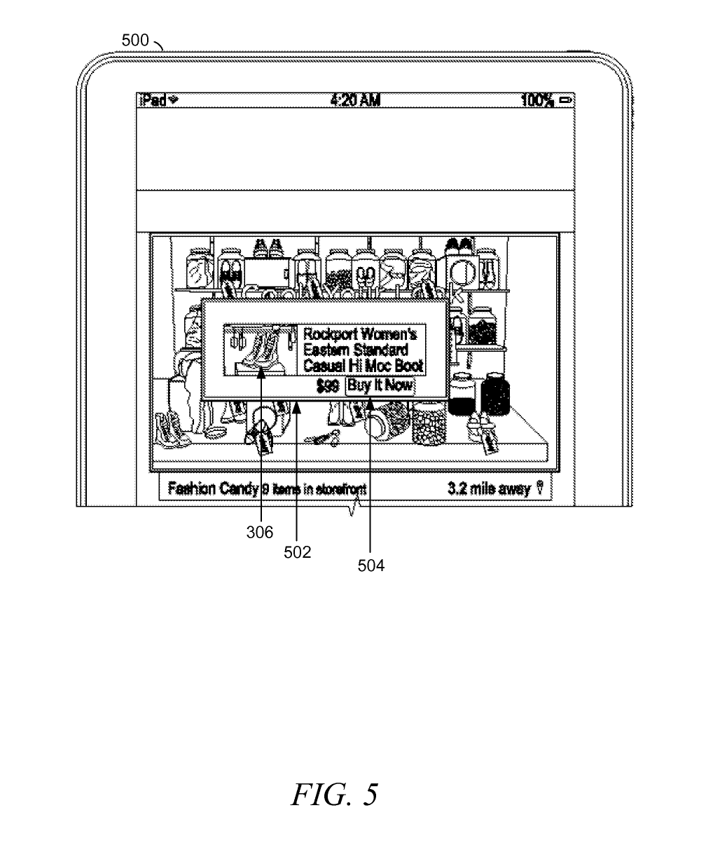

FIG. 5 is an example user interface of a storefront image 500, according to some example embodiments. The storefront image 500 may correspond to a brick-and-mortar store 120. The example user interface of the storefront image 500 may include merchandise information 502 for the second item 306 (as also shown in FIG. 3). In various example embodiments, the storefront image 500 is presented by the display module 230 to the user device (e.g., device 150) in response to the reception module 210 detecting operation of a user interface element corresponding to the second item 306.

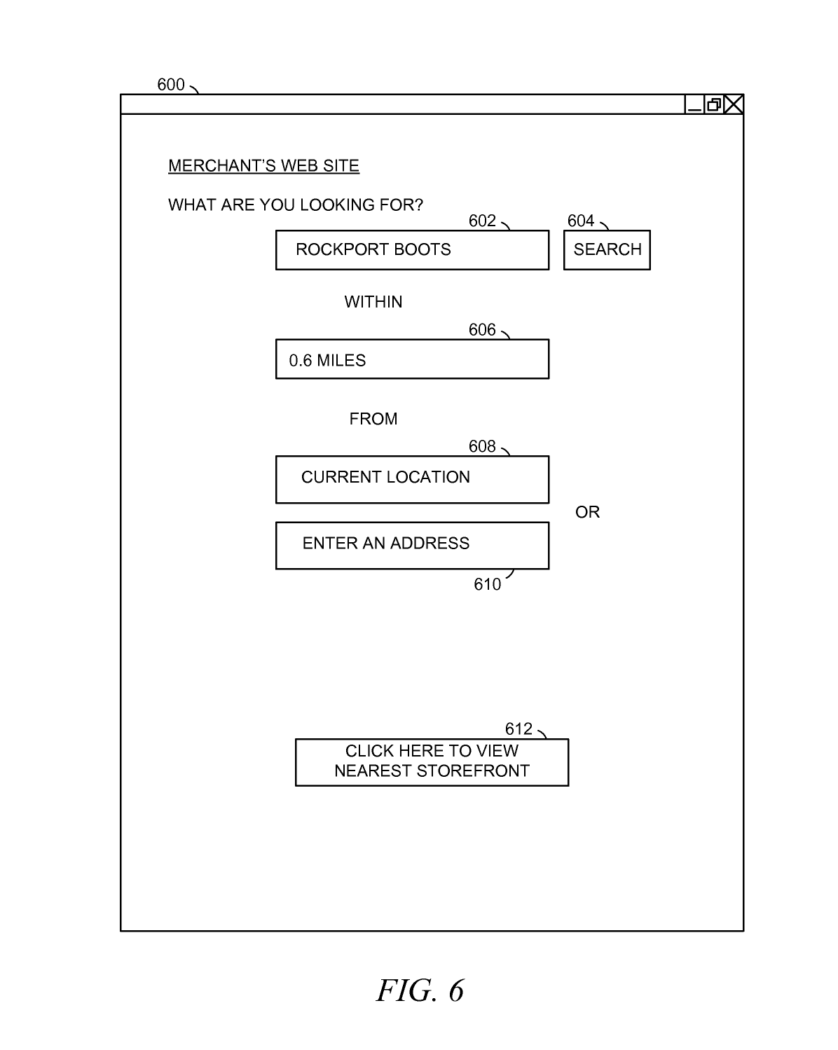

FIG. 6 is an example of user interface 600 of an online page that corresponds to the brick-and-mortar store, according to some example embodiments. The user interface 600 of the online page may be usable to perform a search for a storefront image. The user interface 600 may include search fields that are usable to provide search criteria. The user interface 600 may include a first search field 602, a second search field 606, a third search field 608, and a fourth search field 610, each of which may be usable to provide search criteria. The first search field 602 may be used to provide a description of an item (e.g., “Rockport boots”). The second search field 606 in conjunction with the third and fourth search fields 608, 610 may be used to perform a location based search (e.g., a search for a location 0.6 miles from an address or a current location). Moreover, the search may be performed in response to operation of the search button 604. In various example embodiments, the user interface 600 may also include a link 612 that is operable to display the storefront image.

In various example embodiments, the storefront image 400 (as shown in FIG. 4) may be accessed by the access module 220 in response to the search criteria provided in FIG. 6. For instance, the storefront image 400 may include item 306 that matches with the description of the item provided in the first search field 602 of FIG. 6 (e.g., “Rockport boots”). Moreover, the storefront image 608 may be satisfy the conditions specified in the second search field 606 in conjunction with the third and fourth search fields 608, 610 (e.g., a search for a location 0.6 miles from an address or a current location). Alternatively, the storefront image 400 may be accessed by the access module 220 in response to operation of the link 612 included in the user interface 600. The operation of the link may be detected by the reception module 210.

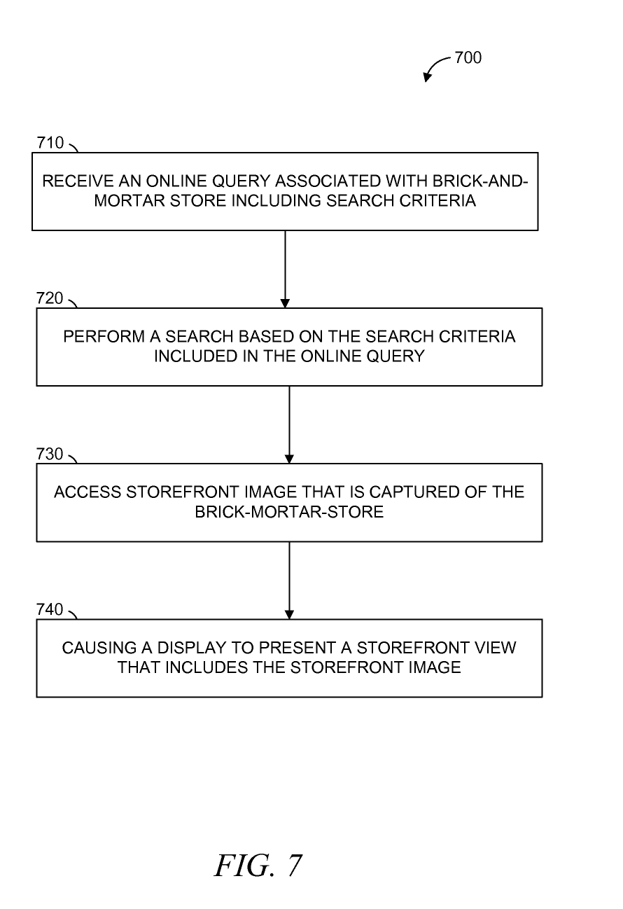

FIG. 7 is a flowchart illustrating a method 700 of causing a display to present a virtual storefront that includes a storefront image, according to some example embodiments. Operations in the method 700 may be performed by the image machine 110, using modules described above with respect to FIG. 2. At operation 710, the reception module 210 may receive from a user device (e.g., device 150) an online query associated with a brick-and-mortar store 120. In various example embodiments, the online query associated with the brick-and-mortar store 120 may include search criteria usable to identify a brick-and-mortar store.

At operation 720, the access module 220 may perform a search based on the search criteria included in the online query. In various example embodiments, the access module 220 is further configured to access the storefront image based on the search criteria that match with the one or more of the merchandise items at the brick-and-mortar store. Alternatively, the search criteria may indicate the brick-and-mortar store 120 (e.g., address of the brick-and-mortar store 120, name of the brick-and-mortar 120, description of the brick-and-mortar store 120). The access module 220 may access the storefront image based on the search criteria that indicates the brick-and-mortar store 120. In various example embodiments, the access module is further configured to access the storefront image based on the location data of the user device (e.g., device 150) received at the reception module 210. For instance, the access module 220 may compare the location of the brick-and-mortar store 120 with the location of the user device (e.g., device 150) and determine that a distance between the locations of the user device and the brick-and-mortar store is within a predetermined threshold. In other words, a plurality of brick-and-mortar stores, including the brick-and-mortar store 120, may be identified that satisfy the search criteria and that are located within a predetermined threshold data from the user device, as indicated by the received location data received at the reception module 210.

At operation 730, the access module 220 may access a storefront image that is captured of a storefront of the brick-and-mortar store 120. The storefront image may be accessed from the database 112. Moreover, the storefront image may be previously captured by a further device (e.g., client device 130) operated by a further user (e.g., client 132) and stored in the database 112 by the reception module 210.

At operation 740, the display module 230 may cause a display on the user device (e.g., device 150) to present a virtual storefront that includes the storefront image accessed by the access module 220. The display module 230 may cause the display to present the virtual storefront in response to the received online query from the user device. Moreover, the virtual storefront may include respective merchandise information for one or more of the merchandise items represented in the storefront image.

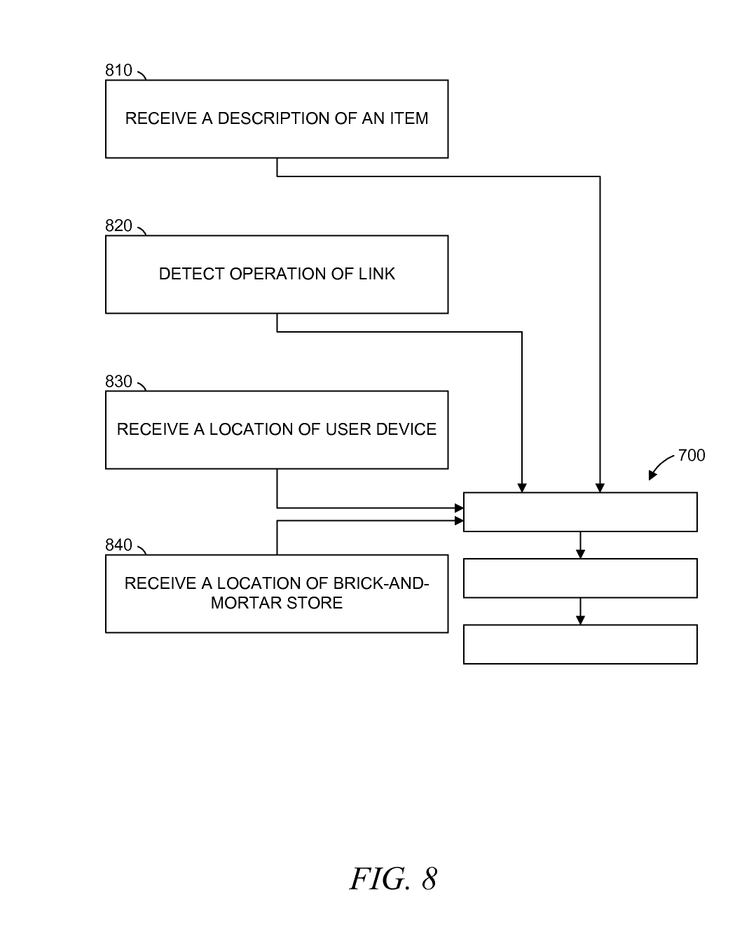

FIG. 8 is a flowchart illustrating a method 700 of causing a display to present a virtual storefront that includes a storefront image, according to some example embodiments. At operation 810, the reception module 210 receives a description of an item. In various example embodiments, the access module 220 accesses the storefront image based on the description of the item received at the reception module 210. For instance, the storefront image may depict an item that matches the description of the item received at the reception module 210.

At operation 820, the reception module 210 detects operation of a link performed by the user device. The link may be included in an online page that corresponds to the brick-and-mortar store. The online page that corresponds to the brick-and-mortar store may be accessed by the user device (e.g., user typing in address of the online page into a web browser on the user device). In various example embodiments, the access module 220 accesses the storefront image based on the operation of the link. In various example embodiments, the display module 230 is displays the storefront image on the online page corresponding to the brick-and-mortar store 120 in response to the reception module 210 detecting the operation of the link.

At operation 830, the reception module 210 receives a location of the user device. The location may be retrieved from the user device and obtained using a GPS receiver that is attached to the user device. In various example embodiments, the access module 220 accesses the storefront image based on the location of the user device received at the reception module 210.

At operation 840, the reception module 210 receives a location of the brick-and-mortar store from the user device. For instance, the reception module 210 may receive an address of the brick-and-mortar store from the user device (e.g., user typing in the address of the brick-and-mortar store onto a webpage with the user device). In response, the access module 220 accesses the storefront image based on the address of the brick-and-mortar store.

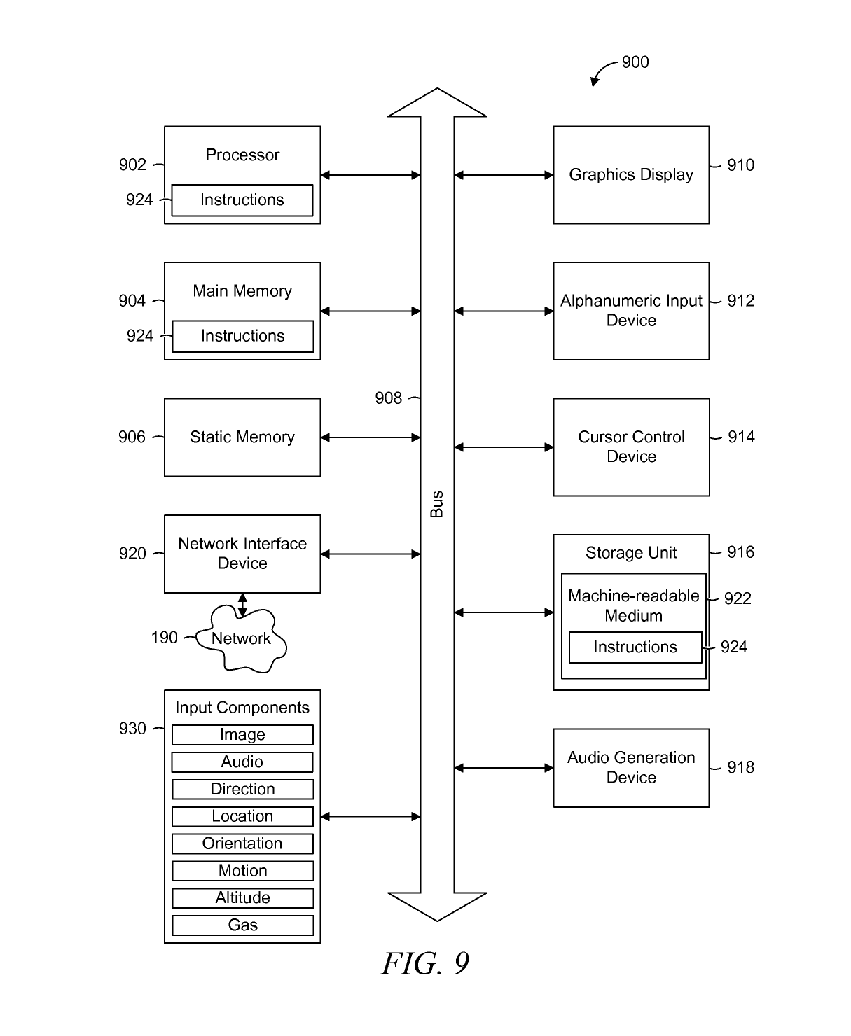

FIG. 9 is a block diagram illustrating components of a machine 900, according to some example embodiments, able to read instructions 924 from a machine-readable medium 922 (e.g., a machine-readable storage medium, a computer-readable storage medium, or any suitable combination thereof) and perform any one or more of the methodologies discussed herein, in whole or in part. Specifically, FIG. 9 shows the machine 900 in the example form of a computer system within which the instructions 924 (e.g., software, a program, an application, an applet, an app, or other executable code) for causing the machine 900 to perform any one or more of the methodologies discussed herein may be executed, in whole or in part. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 190 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving from a user device a search query indicating retail-related search criteria; and
in an automated operation performed by one or more processors, causing display on the user device of a search result based on the search query, the search result comprising one or more search result items respectively comprising a storefront image representing a storefront of a corresponding brick-and-mortar store, wherein a respective plurality of merchandise items is visible in each storefront image.

2. The method of claim 1, wherein each search result item comprises an augmented storefront view based on the corresponding storefront image, each augmented storefront view including respective merchandise information for the associated plurality of merchandise items.

3. The method of claim 1, wherein each search result item comprises and augmented storefront view based on the corresponding storefront image, each augmented storefront view including a plurality of user interface elements associated with respective corresponding merchandise items.

4. The method of claim 3, further comprising:
detecting user selection of a particular one of the user interface elements; and
in response to the detecting the user selection, causing display of merchandise information specific to the merchandise item corresponding to the particular user interface element.

5. The method of claim 3, further comprising facilitating an online transaction via a particular augmented storefront view with respect to a user-selected merchandise item in the corresponding storefront image.

6. The method of claim 5, wherein the facilitating comprises causing display of an e-commerce user interface in response to user selection of one of the plurality of user interface elements of the augmented storefront view.

7. The method of claim 1, further comprising maintaining a database of storefront images for respective brick-and-mortar stores, the maintaining of the database comprising:
receiving an updated storefront image for a specific brick-and-mortar store represented in the database by an outdated storefront image; and
replacing the outdated storefront image for the specific brick-and-mortar store in the database with the updated storefront image.

8. The method of claim 1, wherein the receiving of the search query includes receiving location data of the user device, and wherein the search criteria includes the location data of the user device.

9. The method of claim 8, wherein causing display of the search result comprises causing display of storefront image-based search result items for a plurality of brick-and-mortar stores that satisfy the search criteria and that are located within a predetermined threshold data from the user device, as indicated by the received location data.

10. The method of claim 1, wherein the search criteria comprise merchandise item attributes, and wherein causing the display of the search result comprises causing display of a plurality of storefront image-based search result items, each result item displaying in the respective storefront image at least one merchandise item that satisfies the merchandise item attributes of the search criteria.

11. A system comprising:
a reception module configured to receive from a user device a search query indicating retail-related search criteria; and
a display module configured to cause a display on the user device of a search result based on the search query, the search result comprising one or more search result items respectively comprising a storefront image representing a storefront of a corresponding brick-and-mortar store, wherein a respective plurality of merchandise items is visible in each storefront image.

12. The system of claim 11, wherein each search result item comprises an augmented storefront view based on the corresponding storefront image, each augmented storefront view including respective merchandise information for the associated plurality of merchandise items.

13. The system of claim 11, wherein each search result item comprises and augmented storefront view based on the corresponding storefront image, each augmented storefront view including a plurality of user interface elements associated with respective corresponding merchandise items.

14. The system of claim 13, wherein the reception module is further configured to detect user selection of a particular one of the user interface elements; and wherein the display module is further configured to, in response to the detecting the user selection, cause display of merchandise information specific to the merchandise item corresponding to the particular user interface element.

15. The system of claim 13, wherein the display module is further configured to facilitate an online transaction via a particular augmented storefront view with respect to a user-selected merchandise item in the corresponding storefront image.

16. The system of claim 15, wherein the display module is further configured to cause display of an e-commerce user interface in response to user selection of one of the plurality of user interface elements of the augmented storefront view.

17. The system of claim 11, further comprising an access module configured to:
maintain a database of storefront images for respective brick-and-mortar stores;
receive an updated storefront image for a specific brick-and-mortar store represented in the database by an outdated storefront image; and
replace the outdated storefront image for the specific brick-and-mortar store in the database with the updated storefront image.

18. The system of claim 11, wherein the reception module is further configured to receive location data of the user device, and wherein the search criteria includes the location data of the user device.

19. The system of claim 18, wherein the display module is further configured to cause display of storefront image-based search result items for a plurality of brick-and-mortar stores that satisfy the search criteria and that are located within a predetermined threshold data from the user device, as indicated by the received location data.

20. A non-transitory machine-readable medium storing instructions that, when executed by one or more processors of a machine, cause the machine to perform operations comprising:
receiving from a user device a search query indicating retail-related search criteria; and
causing display on the user device of a search result based on the search query, the search result comprising one or more search result items respectively comprising a storefront image representing a storefront of a corresponding brick-and-mortar store, wherein a respective plurality of merchandise items is visible in each storefront image.
